(19) United States
(12) Patent Application Publication
(10) Pub. No.: US 2010/0213907 A1
(43) Pub. Date: Aug. 26, 2010

(54) Low Drop Out Linear Regulator

(75) Inventors: Ching-Wei Hsueh, Sinshih Township (TW); Kuan-Jen Tseng, Sinshih Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX ANALOGIC, INC., Sinshih Township (TW)

(21) Appl. No.: 12/392,245

(22) Filed: Feb. 25, 2009

(51) Int. Cl. G05F 1/00

(52) U.S. Cl. 323/273

(57) ABSTRACT

A low drop out linear regulator is provided. The low drop out linear regulator comprises an output PMOS, a load, a discharging circuit and an operational amplifier. The output PMOS comprises a source connected to a power supply and a drain having an output voltage and an output current. The drain is connected to a load circuit having a heavy and a light load period. The load is connected to the drain to generate a divided output voltage. The discharging circuit is connected to the drain to discharge the output current from the drain. The operational amplifier is to generate a control voltage according to the divided output voltage and a reference voltage; when the load circuit switches from the heavy to the light load period to make the divided output voltage higher than the reference voltage, the control voltage turns off the output PMOS and activates the discharging circuit.

### BACKGROUND

1. Field of Invention

The present invention relates to a low drop out linear regulator. More particularly, the present invention relates to a low drop out linear regulator with a discharging circuit.

2. Description of Related Art

Low drop out linear regulator is a circuit module that can provide a large current and operate with a very small input-output differential voltage at the same time. However, a load circuit connected to the output of the low drop out linear regulator typically operates between a heavy load period and a light load period. During the light load period, the load circuit doesn't need a large current and it becomes a light load circuit. The current sent from the low drop out linear regulator to the load circuit thus can't be dissipated through the load circuit during the light load period. The slow-discharging current during the light load period would generate a voltage pulse at the output node of the low drop out linear regulator, which is an undesired result.

Accordingly, what is needed is a low drop out linear regulator to provide a fast discharging mechanism when the load circuit switches to the light load period. The present invention addresses such a need.

### SUMMARY

A low drop out linear regulator is provided. The low drop out linear regulator comprises an output PMOS, a load, a discharging circuit and an operational amplifier. The output PMOS comprises a gate, a source connected to a power supply and a drain having an output voltage and an output current, wherein the drain is connected to a load circuit having a heavy load period and a light load period. The load is connected to the drain to generate a divided output voltage according to the output voltage. The discharging circuit is connected to the drain to discharge the output current from the drain, and the operational amplifier is to generate a control voltage according to the divided output voltage and a reference voltage to control the gate of the output PMOS and the discharging circuit; when the load circuit switches from the heavy to the light load period to make the divided output voltage higher than the reference voltage, the control voltage turns off the output PMOS and activates the discharging circuit, when the load circuit switches from the light to the heavy load period to make the divided output voltage lower than the reference voltage, the control voltage turns on the output PMOS and deactivates the discharging circuit.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of a low drop out linear regulator of an embodiment of the present invention; and

FIG. 2 is a diagram of the waveform of the output voltage and the control voltage.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

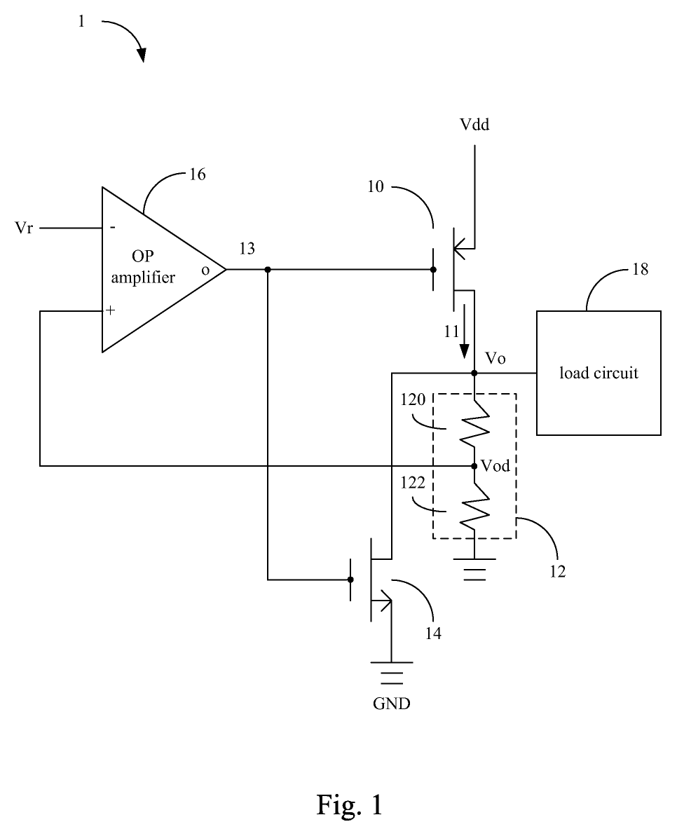

Please refer to FIG. 1. FIG. 1 is a diagram of a low drop out linear regulator 1 of an embodiment of the present invention. The low drop out linear regulator 1 comprises an output PMOS 10, a load 12, a discharging circuit 14 and an operational (OP) amplifier 16. The output PMOS 10 comprises a gate, a source connected to a power supply Vdd, and a drain having an output voltage Vo and an output current 11. The drain is connected to a load circuit 18, wherein the load circuit 18 has a heavy load period and a light load period. The load circuit 18 has strong sourcing ability during the heavy load period. Therefore the drain of the output PMOS 10 will provide a large current to the load circuit 18 and maintain the same level of output voltage Vo. However, when the load circuit 18 operates in the light load period, the load circuit 18 becomes a light load circuit. Only a small part of the output current is dissipated in the load circuit 18. The load 12 is connected to the drain and substantially comprises two resistors 120 and 122 in the present embodiment. Therefore, the load 12 generates a divided output voltage Vod at the connecting point of the two resistors 120 and 122 according to the output voltage Vo. The discharging circuit 14 is connected to the drain of the output PMOS 10 to discharge the output current 11 from the drain of the output PMOS 10. The operational amplifier 16 is to generate a control voltage 13 according to the divided output voltage Vod and a reference voltage Vr to control the gate of the output PMOS 10 and the discharging circuit 14. The operational amplifier 16 comprises a non-inverting input, an inverting input and an amplifier output. The non-inverting input (indicated by symbol “+” in FIG. 1) is connected to the load to receive the divided output voltage Vod. The inverting input (indicated by symbol “−” in FIG. 1) to receive the reference voltage Vr. The amplifier output (indicated by symbol “o” in FIG. 1) is connected to the gate of the output PMOS 10 to transfer the control voltage 13.

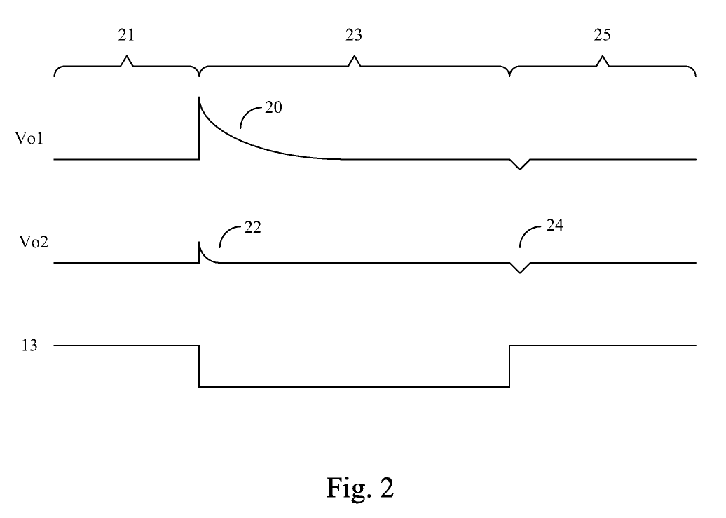

Please refer to FIG. 2 at the same time. FIG. 2 is a diagram of the waveform of the output voltage Vo and the control voltage 13. In FIG. 2, Vo1 is the waveform of the output voltage Vo when the discharging circuit 14 is not present, and Vo2 is the waveform of the output voltage Vo when the discharging circuit 14 is present as depicted in FIG. 1. The period 21 shown in FIG. 2 stands for the heavy load period 21, the period 23 stands for the light load period 23 and the period 25 stands for the next heavy load period 25. If the discharging circuit 14 is not present, a voltage pulse 20 will be generated when the load circuit 18 switches from the heavy load period 21 to the light load period 23 due to the different amount of the output current 11 sourced by the load circuit 18. The remaining output current 11 that is not sourced by the load circuit 18 will be discharged through the load 12. The slow discharging of the load 12 results in the voltage pulse 20 and longer discharging time, which is an undesirable result.

The discharging circuit 14 in the present embodiment of the present invention provides a fast discharging mechanism. The discharging circuit 14 is substantially an NMOS 14 comprising a drain connected to the drain of the output PMOS 10, a source connected to a ground potential GND and a gate connected to the amplifier output of the operational amplifier 16 to receive the control voltage 13. When the load circuit 18 switches from the heavy load period 21 to the light load period 23, the output current 11 that can't be dissipated through the load circuit 18 makes the output voltage Vo increase. Thus, the divided output voltage Vod increases as well and becomes higher than the reference voltage Vr. The operational amplifier 16 generates the control voltage 13 such that the control voltage 13 becomes high to turn off the output PMOS 10 and activate the discharging circuit 14 immediately, wherein the waveform of the control voltage 13 is depicted in FIG. 2. Therefore, the output PMOS 10 stops providing the output current 11, and the output current 11 already generated discharges through both the load 12 and the discharging circuit 14. The fast discharging mechanism will make the discharging time becomes shorter and the voltage pulse 22 on the output voltage Vo dramatically reduce as well, as the waveform of Vo2 depicted in FIG. 2. When the load circuit 18 switches from the light load period 23 to the next heavy load period 25, the load circuit 18 starts to source the output current 11 and make a voltage drop 24 on the output voltage Vo to further make the divided output voltage Vod drops as well. The divided output voltage Vod becomes lower than the reference voltage Vr to make the operational amplifier 16 generate the control voltage 13 such that the control voltage 13 becomes low to turn on the output PMOS 10 and deactivate the discharging circuit 14 to supply the output current 11 to the load circuit 18.

The advantage of the low drop out linear regulator of the present invention is use the control voltage generated according to the output voltage to provide a fast switching ability to switch the operation of the output PMOS and the discharging circuit and further provide a fast discharging mechanism to shorten the discharging time and reduce the voltage pulse of the voltage output.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A low drop out linear regulator comprising:
an output PMOS comprising:
a gate;
a source connected to a power supply; and
a drain having an output voltage and an output current, wherein the drain is connected to a load circuit having a heavy load period and a light load period;
a load connected to the drain to generate a divided output voltage according to the output voltage;
a discharging circuit connected to the drain to discharge the output current from the drain; and
an operational amplifier to generate a control voltage according to the divided output voltage and a reference voltage to control the gate of the output PMOS and the discharging circuit;
when the load circuit switches from the heavy to the light load period to make the divided output voltage higher than the reference voltage, the control voltage turns off the output PMOS and activates the discharging circuit, when the load circuit switches from the light to the heavy load period to make the divided output voltage lower than the reference voltage, the control voltage turns on the output PMOS and deactivates the discharging circuit.

2. The low drop out linear regulator of claim 1, wherein the operational amplifier comprises:
a non-inverting input connected to the load to receive the divided output voltage;
an inverting input to receive the reference voltage; and
an amplifier output connected to the gate of the output PMOS to transfer the control voltage.

3. The low drop out linear regulator of claim 1, wherein the discharging circuit comprises an NMOS comprising a drain connected to the drain of the output PMOS, a source connected to a ground potential and a gate to receive the control voltage.

4. The low drop out linear regulator of claim 1, wherein the load comprises a plurality of resistors to generate the divided output voltage.

5. The low drop out linear regulator of claim 1, when the load circuit is in light load period, the current of the drain discharges through both the load and the discharging circuit.
